(19) United States
(12) Patent Application Publication
(10) Pub. No.: US 2008/0094374 A1
(43) Pub. Date: Apr. 24, 2008

(54) Control device for a spreader

(76) Inventor: Paul Treuthardt, Monroe, WI (US)

Correspondence Address: DAVID J. ARCHER, 7037 POMERY ROAD, ROCKTON, IL, 61072, US

(21) Appl. No.: 11/800,713

(22) Filed: May 7, 2007

Related U.S. Application Data
(60) Provisional application No. 60/798,208, filed on May 5, 2006.

(51) Int. Cl. G06F 3/045; G06F 3/041; G06F 3/043; G06F 3/044

(52) U.S. Cl. 345/174; 345/173; 345/177

(57) ABSTRACT

A control device is disclosed for a spreader for spreading materials on a road. The device includes a touch screen for entering information and an arrangement associated with the touch screen for processing the information and for providing a color display. The device also includes a color display which permits a user to view displayed information in multiple colors.

### CROSS REFERENCE TO RELATED APPLICATION

The present application is a Complete application pursuant to the Provisional application U.S. Ser. No. 60/798,208 filed May 5 2006. All of the disclosure of U.S. Ser. No. 60/798,208 is incorporated herein by reference.

### BACKGROUND OF THE INVENTION

1. Field of the Invention

The present invention relates to a spreader device for spreading material on roadways, airport runways and the like such as a spreader device used for the snow and ice control industry. More specifically, the present invention relates to a control device for a spreader for surface conditioning of roads and highways by spreading materials for controlling snow and ice. Importantly, the control device for the spreader of the present invention is adapted to facilitate the spreader functions and is provided with user friendly features for ready visual indication of control parameters and related information input and generation.

2. Background Information

It is well known to spread salt and sand to maintain a road during winter months especially to remove snow and ice from the road and to clear airport runways. For such purposes it is also known to use a variety of spreaders which are attached to a conventional vehicle and which are used to spread the salt and sand and the like on the road. While there are many types of such spreaders, typically there are spreader mounting assemblies, which are used in conjunction with dump trucks and wherein the spreader is fastened adjacent to the tail gate of the truck.

Such spreaders are commonly used to convey materials such as salt, chemicals and/or sand for the purpose of spreading these materials onto the road surface thereby improving the road conditions.

In the use of spreaders for the snow and ice control industry, the spreaders usually include a spinner which is adapted to create a wide spray pattern behind the vehicle carrying the spreader in the process of spreading the conveyed material. Also depending upon the surface condition to be treated, the conveyed materials in case of the use of the spreader for the snow and ice industry thus include anti-ice agents and also preferably pre-wet agents.

Also for such surface conditioning or treatment, vehicles carrying spreaders can be used for a variety of purposes and are known to include snow plows, blowers and material spreaders alone or in combination. Importantly, the variety of applications require spreading of more than one material simultaneously in either a synchronous or asynchronous manner in either a predetermined ratio or in random proportions to a surface.

Moreover, the spreader may be required to apply material to a surface that can be all liquid, all solids or a combination thereof. In particular, in case of pre-wetting arrangements, both liquid and granular materials must be dispersed through a common device such as a spinner disk. The content of the granular material is usually higher with respect to the quantity of the liquid. Importantly, the material characteristics such as the granularity, density, viscosity and flow ability determine whether a separate or a common delivery system for such materials must be provided.

Spreaders used for spreading materials on roadways and airport runways for the control of ice and snow thus often involve both granular and liquid material to be spread simultaneously and the operator must set the spread width of the granular material and also the liquid material according to the width of the road to be covered. In particular, in case of a change in the width of the road and also depending on the ice and snow to be cleared, the operator is required to monitor and adjust the spread width and other spread parameters to suit the desired end application.

Accordingly, those skilled in the art will appreciate that spreaders and their function and operation essentially require continuous and constant monitoring of the various control parameter and the input of necessary instructions to activate the spreader for spreading the material at desired levels to achieve the optimum results.

Accordingly, the present invention provides a control device for a spreader for spreading material on a road and the like such as those required for the snow and ice control industry, which employs user friendly controls and activation of the spreader system.

More specifically, the present invention relates to a control device for a spreader for spreading material on a road which includes a visually appealing multi color display of control parameters.

The present invention also provides a control device for a spreader for spreading material on a road which is user friendly during operation and which does not require the typically used keyboard or mouse to input instructions for operation of the spreader.

In particular, according to the present invention, the control device for a spreader for spreading material on a road finds particular application in spreader units requiring monitoring of control parameter and activating the spreader functions according to the required end use or purpose.

Therefore, it is a primary feature of the present invention to provide a control device for a spreader used for spreading material on a road which overcomes the complexities of monitoring control parameters and/or carrying out typical functions of a spreader device which uses a conventional key board and mouse for the input of instructions for effectively operating the device.

Another feature of the present invention is to provide a visually appealing multiple color display of control parameters representing certain functions or a level of warnings in a spreader system.

A further feature of the present invention is to provide a user friendly operation and use of a spreader system involving a touch screen which would enable the user to use the user□s finger or a type of stylus to press against the display area and enter information into the system.

A further feature of the present invention is directed to improve the design feature and aesthetic appearance of a spreader device and in the process make it simple and user friendly to the end user or operator.

Other features and advantages of the present invention will be readily apparent to those skilled in the art by a consideration of the detailed description of a preferred embodiment of the present invention contained herein.

### SUMMARY OF THE INVENTION

The present invention relates to a spreader control device for the snow and ice control industry. Advantageously, the control device of the spreader includes a touch screen for entering information, the screen being operatively connected to means for processing the information and providing color display of the output. The color display is adapted preferably to permit a user to view displayed information in multiple colors. Such a color display in the control device of the present invention is adapted to display information in more than two colors thereby providing displayed information that is visually appealing and convenient to the user. Importantly, the control device of the present invention thus is adapted, through the use of programming, to permit representing certain functions or levels of warning by way of visual color representation.

The color display types that can typically be used in the control device are Liquid Crystal Module (LCM) or Liquid Crystal Display (LCD). The screens can be typically graphical type displays. However, character type displays can also be used.

The Liquid Crystal Display (LCD) or Liquid Crystal Module (LCM) types that are used in the control system of the present invention can be selected from Twisted Nematic, High Twisted Nematic, Super Twisted Nematic, Formulated Super Twisted Nematic, Color Super Twisted Nematic, Thin Film Transistor or Organic Electro Luminescent. The LCD or LCM used in the control device can also be of reflective or transflective construction. In accordance with a preferred aspect of the present invention, the color display can be provided with backlight as an option depending upon the user's requirements.

The touch screen used in the control device basically involves a transparent overlay adapted to allow the user to use the user□s finger or a type of stylus to press against the display area and enter information into the system. The touch screen used in the control device can be selected from of any one of the basic types of touch screen including resistive, capacitive, infrared, surface acoustic wave and strain gauge type of touch screens.

Many modifications and variation in the present invention will be readily apparent to those skilled in the art by a consideration of the detailed description contained hereinafter taken in conjunction with the annexed drawings which show a preferred embodiment of the present invention. However, such modifications and variations fall within the spirit and scope of the present invention as defined by the appended claims.

### BRIEF DESCRIPTION OF THE DRAWINGS

FIG. 1 is a side elevational view of a control board of the control device according to the present invention; and

FIG. 2 is a side elevational view of a display and touch screen according to the present invention.

Similar reference characters refer to the same parts throughout the Figures of the drawings.

### DETAILED DESCRIPTION OF THE DRAWINGS

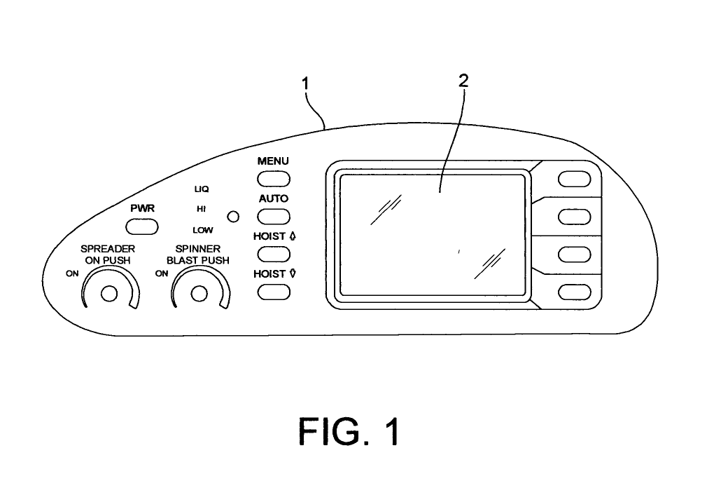

FIG. 1, is side elevational view of a control board which is generally designated according to the present invention. As shown in FIG. 1, the control device of the present invention is for a spreader and includes the control board 1 which is provided with color display means which is preferably a Liquid Crystal Module or a Liquid Crystal Display 2.

As apparent from FIG. 1, such color display 2 is adapted to enable the user to view the display and the information in multiple colors. Such a color display involves anything that displays more than two colors. Through the use of programming, the functions of the spreader can be arranged to have visual color representation identifying certain functions or levels of warning. While the Figs. of the drawings represent the typically used color display types it is also possible to use other visual display in multiple colors to identify functions or levels of warning.

Advantageously, in accordance with one aspect of the present invention, such LCD or LCM can be of reflective or transflective construction. Also preferably the color display can also include backlight as an option depending on the end user's requirements for the control device.

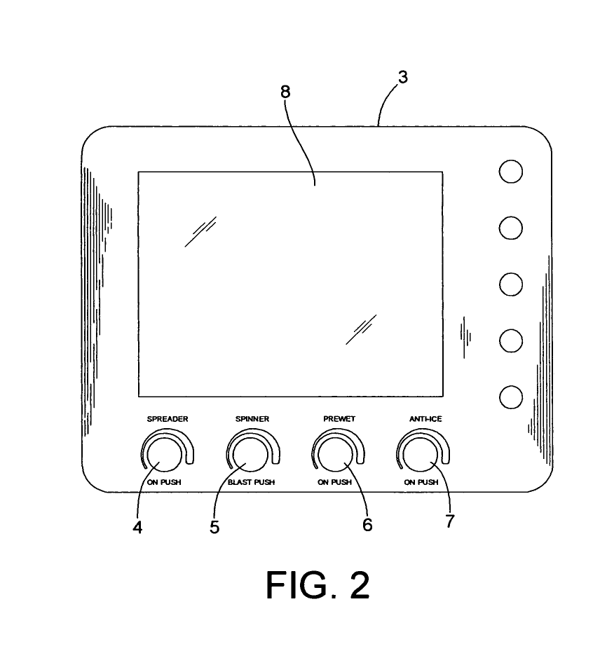

FIG. 2 is a side elevational view of a display and touch screen in accordance with the control device of the present invention. As illustrated in FIG. 2, the touch screen 3 is arranged with activating provisions to activate the spreader to an on position 4, a spinner blast push 5, pre-wet on 6 and an anti-ice on 7.

Advantageously, by use of a transparent overlay, the touch screen 3 is arranged to allow the user to use the user's finger or a type of stylus to press against a display area 8 to enter information into the system. Such an arrangement by way of the provision of the touch screen in the control device of the invention is directed to replace the functions of the typical functions associated with the provision of a keyboard or mouse to enter information into a conventional spreader system.

The touch screen 3 as used in the control device of the present invention can be selected from any one of the known varieties which includes, resistive, capacitive, infrared, surface acoustic wave and strain gauge type of touch screens.

Thus, using the above control device of the present invention, the actual surface conditions and observations may also be entered into the computer very simply and readily through the use of the touch screen especially in those circumstances that are not predicted or that need correction. Such situation can be due to traffic patterns at a particular location or along a particular route which can differ at different times. Thus depending upon the road conditions, the spreader mix is selectively determined to suit the immediate requirements which can be more appropriate than the computer generated amounts and proportions which may not be based on such changed surface conditions. Thus, by way of the control device of the present invention, it is possible to continuously monitor and readily instruct the spreader functions depending upon the required spreading operation. Also, the operator can attend to the monitoring and can further observe the effectiveness of the operation at the control panel. Additionally, the display panel provides visually appealing multi color indications of the functions and warning levels of operative parameters relative to the spreader activity.

The control device for the spreader in accordance with the present invention has been described above with reference to a particular embodiment thereof, which is shown by way of example only and not by way of limitations. It is possible to provide changes, alternatives, variations and modifications of such exemplary embodiment of the color display and touch screen embodiment based control device of the invention. For example, while the color display types are shown to be Liquid Crystal Module or Liquid Crystal Display, the present invention is not limited to such typically used color display types. Accordingly, it is intended that all such possible alternatives and variations and modifications to the embodiment be included within the scope of the present invention as defined by the appended claims.

What is claimed is:

1. A control device for a spreader for spreading materials on a road, said device comprising:
a touch screen for entering information;
means associated with said touch screen for processing said information and for providing a color display; and
said color display permitting a user to view displayed information in multiple colors.

2. A control device for a spreader as set forth in claim 1 wherein
said color display represents specific functions and levels of warning.

3. A control device for a spreader as set forth in claim 1 wherein
said color display includes:
a Liquid Crystal Module (LCM).

4. A control device for a spreader as set forth in claim 1 wherein
said color display includes:
a Liquid Crystal Display (LCD).

5. A control device for a spreader as set forth in claim 1 wherein
said color display screens includes:
a Graphical Type Display.

6. A control device for a spreader as set forth in claim 1 wherein
said color display screens includes:
a Character Type Display.

7. A control device for a spreader as set forth in claim 4 wherein
said Liquid Crystal Display (LCD) includes:
a Twisted Nematic.

8. A control device for a spreader as set forth in claim 4 wherein
said Liquid Crystal Display (LCD) includes:
a High Twisted Nematic.

9. A control device for a spreader as set forth in claim 4 wherein
said Liquid Crystal Display (LCD) includes:
a Super Twisted Nematic.

10. A control device for a spreader as set forth in claim 4 wherein
said Liquid Crystal Display (LCD) includes:
a formulated Super Twisted Nematic.

11. A control device for a spreader as set forth in claim 4 wherein
said Liquid Crystal Display (LCD) includes:
a color Super Twisted Nematic.

12. A control device for a spreader as set forth in claim 4 wherein
said Liquid Crystal Display (LCD) includes:
a thin film transistor organic Electo Luminescent.

13. A control device for a spreader as set forth in claim 3 wherein
said Liquid Crystal Modules (LCM) includes:
a Twisted Nematic.

14. A control device for a spreader as set forth in claim 3 wherein
said Liquid Crystal Modules (LCM) includes:
a High Twisted Nematic.

15. A control device for a spreader as set forth in claim 3 wherein
said Liquid Crystal Modules (LCM) includes:
a Super Twisted Nematic.

16. A control device for a spreader as set forth in claim 3 wherein
said Liquid Crystal Modules (LCM) includes:
a formulated Super Twisted Nematic.

17. A control device for a spreader as set forth in claim 3 wherein
said Liquid Crystal Modules (LCM) includes:
a color Super Twisted Nematic.

18. A control device for a spreader as set forth in claim 3 wherein
said Liquid Crystal Modules (LCM) includes:
a thin film transistor organic Electo Luminescent.

19. A control device for a spreader as set forth in claim 4 wherein
said Liquid Crystal Display (LCD) includes:
a reflective construction.

20. A control device for a spreader as set forth in claim 4 wherein
said Liquid Crystal Display (LCD) includes:
a transreflective construction.

21. A control device for a spreader as set forth in claim 3 wherein
said Liquid Crystal Modules (LCM) includes:
a reflective construction.

22. A control device for a spreader as set forth in claim 3 wherein
said Liquid Crystal Modules (LCM) includes:
a transreflective construction.

23. A control device for a spreader as set forth in claim 4 wherein
said Liquid Crystal Display (LCD) includes:
a backlight.

24. A control device for a spreader as set forth in claim 3 wherein
said Liquid Crystal Modules (LCM) includes:
a backlight.

25. A control device for a spreader as set forth in claim 1 wherein
said touch screen includes:
a resistive touch screen.

26. A control device for a spreader as set forth in claim 1 wherein
said touch screen includes:
a capacitive type touch screen.

27. A control device for a spreader as set forth in claim 1 wherein
said touch screen includes:
a infrared type touch screen.

28. A control device for a spreader as set forth in claim 1 wherein
said touch screen includes:
a surface acoustic wave type touch screen.

29. A control device for a spreader as set forth in claim 1 wherein
said touch screen includes:
a strain gauge type touch screen.

30. A control device for a spreader for spreading materials on a road, said device comprising:
a touch screen for entering information;
means associated with said touch screen for processing said information and for providing a color display;
said color display permitting a user to view displayed information in multiple colors; and
said color display represents specific functions and levels of warning.

31. A control device for a spreader for spreading materials on a road, said device comprising:
a touch screen for entering information;
means associated with said touch screen for processing said information and for providing a color display;
said color display permitting a user to view displayed information in multiple colors;
said color display representing specific functions and levels of warning;
said color display including:
a Liquid Crystal Display (LCD),
said (LCD) including:
a Character Type Display.
said Liquid Crystal Display (LCD) including:
at least one of a Twisted Nematic, a High Twisted Nematic, a Super Twisted Nematic, a formulated Super Twisted Nematic, a color Super Twisted Nematic and a thin film transistor organic Electo Luminescent;
said Liquid Crystal Display (LCD) further including:
a backlight; and
said touch screen including:
at least one of a resistive touch screen, a capacitive type touch screen, a resistive touch screen, an infrared type touch screen, a surface acoustic wave type touch screen and a strain gauge type touch screen.
